(19) United States
(12) Patent Application Publication
(10) Pub. No.: US 2023/0387381 A1
(43) Pub. Date: Nov. 30, 2023

(54) SULFIDE-IMPREGNATED COLUMNAR SILICON ANODE FOR ALL-SOLID-STATE BATTERY AND METHOD OF FORMING THE SAME

(71) Applicant: GM GLOBAL TECHNOLOGY OPERATIONS LLC, Detroit, MI (US)

(72) Inventors: Zhe LI, Shanghai (CN); Xingcheng XIAO, Troy, MI (US); Yong LU, Shanghai (CN); Haijing LIU, Shanghai (CN); Mark W. VERBRUGGE, Troy, MI (US)

(73) Assignee: GM GLOBAL TECHNOLOGY OPERATIONS LLC, Detroit, MI (US)

(21) Appl. No.: 17/869,580

(22) Filed: Jul. 20, 2022

(30) Foreign Application Priority Data
May 24, 2022 (CN) 202210568832.8

(51) Int. Cl. H01M 4/134; H01M 10/0562; H01M 4/62; H01M 4/04; H01M 10/0525

(52) U.S. Cl. CPC H01M 4/134; H01M 10/0562; H01M 4/625; H01M 4/0423; H01M 10/0525; H01M 2004/021

(57) ABSTRACT

An all-solid-state electrochemical cell is provided. The electrochemical cell includes an electrode having a current collector that defines a major axis, and an electroactive material layer disposed on or adjacent to the current collector. The electroactive material layer includes a plurality of hierarchical silicon columns, and a solid sulfide electrolyte. The solid sulfide electrolyte is formed in-situ and fills greater than or equal to about 60 vol. % to less than or equal to about 100 vol. % of voids in the electroactive material layer. The voids being defined by openings between the hierarchical silicon columns. A longest dimension of each hierarchical silicon columns is perpendicular to the major axis of the second current collector.

### CROSS-REFERENCE TO RELATED APPLICATIONS

This application claims the benefit and priority of Chinese Application No. 202210568832.8, filed May 24, 2022. The entire disclosure of the above application is incorporated herein by reference.

### INTRODUCTION

This section provides background information related to the present disclosure which is not necessarily prior art.

Electrochemical energy storage devices, such as lithium-ion batteries, can be used in a variety of products, including automotive products such as start-stop systems (e.g., 12V start-stop systems), battery-assisted systems (“OAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In the instances of solid-state batteries, which includes a solid-state electrolyte layer disposed between solid-state electrodes, the solid-state electrolyte physically separates the solid-state electrodes so that a distinct separator is not required.

Solid-state batteries have advantages over batteries that include a separator and a liquid electrolyte. These advantages can include a longer shelf life with lower self-discharge, simpler thermal management, a reduced need for packaging, and the ability to operate within a wider temperature window. For example, solid-state electrolytes are generally non-volatile and non-flammable, so as to allow cells to be cycled under harsher conditions without experiencing diminished potential or thermal runaway, which can potentially occur with the use of liquid electrolytes. However, solid-state batteries often experience comparatively low power capabilities. Low power capabilities may be a result of interfacial resistance within the solid-state electrodes caused by limited contact, or void spaces, between the solid-state electroactive particles and/or the solid-state electrolyte particles. Accordingly, it would be desirable to develop high-performance solid-state battery designs, materials, and methods that improve power capabilities, as well as energy density.

### SUMMARY

This section provides a general summary of the disclosure, and is not a comprehensive disclosure of its full scope or all of its features.

The present disclosure relates to solid-state batteries, and more particularly, negative electrodes including columnar silicon and sulfide electrolytes for use in all-solid-state batteries, and to methods of forming and using the same.

In various aspects, the present disclosure provides an electrode for an all-solid-state electrochemical cell. The electrode may include a plurality of hierarchical silicon columns that defines an electroactive material layer, the electroactive material layer having a vacant space defined by openings between the plurality of hierarchical silicon columns; and a solid sulfide electrolyte formed in-situ that fills greater than or equal to about 60 vol. % to less than or equal to about 100 vol. % of the vacant space in the electroactive material layer.

In one aspect, each of the hierarchical silicon columns may have a general oval shape where a first radius is larger than a second radius. The first radius may be greater than or equal to about 0.5 μm to less than or equal to about 40 μm. The second radius may be greater than or equal to about 0.5 μm to less than or equal to about 40 μm. Each of the hierarchical silicon columns may have an areal capacity that is greater than or equal to about 0.5 mAh/cm² to less than or equal to about 20 mAh/cm².

In one aspect, the first radius may be about 3.5 μm, and the second radius may be about 3 μm.

In one aspect, the electroactive material layer may include greater than or equal to about or exactly 70 wt. % to less than or equal to about or exactly 100 wt. % of the plurality of hierarchical silicon columns, and greater than 5 wt. % to less than or equal to about or exactly 30 wt. % of the solid sulfide electrolyte.

In one aspect, the electroactive material layer may further include solid-state graphite particles coated on or dispersed between the hierarchical silicon columns, where the vacant spaces are defined as any openings in the electroactive material layer not occupied by the plurality of hierarchical silicon columns and the solid-state graphite particles.

In one aspect, the electroactive material layer may include greater than 0 wt. % to less than or equal to about 70 wt. % of the solid-state graphite particles. The solid-state graphite particles may have an average particle size that is greater than or equal to about 0.05 μm to less than or equal to about 20 μm.

In one aspect, the electrode may further include a current collector having a roughened surface disposed on or adjacent to the electroactive material layer. A longest dimension of each hierarchical silicon column may be perpendicular to a major axis of the current collector.

In one aspect, the roughened surface may have a Rz that is greater than 1 μm to less than or equal to about 12 μm.

In various aspects, the present disclosure provides an all-solid-state electrochemical cell that cycles lithium ions. The electrochemical cell may include a first electrolyte and a second electrode. The first electrode may include a first current collector, and a first electroactive material layer disposed on or adjacent to the first current collector. The second electrode may include a second current collector that defines a major axis, and a second electroactive material layer disposed on or adjacent to the second current collector. The second electroactive material layer may include a plurality of hierarchical silicon columns, and a solid sulfide electrolyte. The solid sulfide electrolyte may be formed in-situ and may fill greater than or equal to about 60 vol. % to less than or equal to about 100 vol. % of voids in the second electroactive material layer. The voids being defined by openings between the hierarchical silicon columns. A longest dimension of each hierarchical silicon columns may be perpendicular to the major axis of the second current collector. The electrochemical cell may further include a solid-state electrolyte layer. The solid-state electrolyte layer may be disposed between the first electroactive material layer and the second electroactive material layer.

In one aspect, each of the hierarchical silicon columns may have a general oval shape where a first radius is larger than a second radius. The first radius may be greater than or equal to about 0.5 μm to less than or equal to about 40 μm. The second radius may be greater than or equal to about 0.5 μm to less than or equal to about 40 μm. Each of the hierarchical silicon columns may have an areal capacity greater than or equal to about 0.5 mAh/cm² to less than or equal to about 20 mAh/cm².

In one aspect, the electroactive material layer may further include greater than 0 wt. % to less than or equal to about 70 wt. % of solid-state graphite particles coated on or disbursed between the hierarchical silicon columns. The voids defined by any openings in the second electroactive material layer not occupied by the hierarchical silicon columns and the solid-state graphite particles. The solid-state graphite particles may have an average particle size greater than or equal to about 0.05 μm to less than or equal to about 20 μm.

In one aspect, the current collector may have a roughened surface. The electroactive material may layer be disposed on or adjacent to roughened surface of the current collector. The roughened surface may have a Rz greater than 1 μm to less than or equal to about 12 μm.

In various aspects, the present disclosure provides a method for forming an electrode. The electrode may include a plurality of hierarchical silicon columns and a solid sulfide electrolyte. The method may include contacting a columnar silicon anode film and a precursor electrolyte to form a precursor assembly. The columnar silicon anode film includes the hierarchical silicon columns. The precursor electrolyte fills voids in the columnar silicon anode film, where the voids are defines by openings between the hierarchical silicon columns. The precursor electrolyte solution may include a plurality of sulfide particles and a solvent. The method may further include removing the solvent from the precursor assembly to form the solid sulfide electrolyte.

In one aspect, the solvent may be selected from the group consisting of: tetrahydrofuran, ethyl propionate, ethylacetate, acetonitrile, water, N-methyl formamide, methanol, ethanol, 1,2-dimethoxyethane, and combinations thereof.

In one aspect, the method may further include forming the columnar silicon anode film. The forming may include a controlled physical vapor deposition (PVD) process.

In one aspect, each of the hierarchical silicon columns may have a general oval shape where a first radius is larger than a second radius. The first radius may be greater than or equal to about 0.5 μm to less than or equal to about 40 μm. The second radius may be greater than or equal to about 0.5 μm to less than or equal to about 40 μm. Each of the hierarchical silicon columns may have an areal capacity greater than or equal to about 0.5 mAh/cm² to less than or equal to about 20 mAh/cm².

In one aspect, removing the solvent may include heating the precursor assembly to a temperature greater than or equal to about 60° C. to less than or equal to about 200° C., and holding the temperature for a period greater than or equal to about 2 hours to less than or equal to about 20 hours.

In one aspect, the columnar silicon anode film may further include a current collector. The hierarchical silicon columns may be disposed near or adjacent to one or more surfaces of the current collector, and a longest dimension of each hierarchical silicon column may be perpendicular to a major axis of the current collector.

In one aspect, the columnar silicon anode film may further include greater than 0 wt. % to less than or equal to about 70 wt. % of solid-state graphite particles coated on or disbursed between the hierarchical silicon columns. The voids defined by any openings in the second electroactive material layer not occupied by the hierarchical silicon columns and the solid-state graphite particles. The solid-state graphite particle may have an average particle size greater than or equal to about 0.05 μm to less than or equal to about 20 μm.

In one aspect, the contacting may include vacuum infiltration of the columnar silicon anode film with the precursor electrolyte solution.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example solid-state battery including a negative electrode having hierarchical silicon columns and a solid sulfide electrolyte in accordance with various aspects of the present disclosure;

FIG. 2 is a schematic illustration of a hierarchical silicon column in accordance with various aspects of the present disclosure;

FIG. 3A is a top-down scanning electron microscopy image of a negative electrode including hierarchical silicon columns;

FIG. 3B is a top-down scanning electron microscopy image of a negative electrode including hierarchical silicon columns and a solid sulfide electrolyte in accordance with various aspects of the present disclosure;

FIG. 3C is a scanning electron microscopy image of a cross-section of a negative electrode including hierarchical silicon columns;

FIG. 3D is a scanning electron microscopy image of a cross-section of a negative electrode including hierarchical silicon columns and a solid sulfide electrolyte in accordance with various aspects of the present disclosure;

FIG. 4 is a flowchart illustrating an example method for forming a negative electrode including hierarchical silicon columns and a solid sulfide electrolyte in accordance with various aspects of the present disclosure;

FIG. 5A is a graphical illustration demonstrating rate performance of an example battery cell including a negative electrode having hierarchical silicon columns and a solid sulfide electrolyte in accordance with various aspects of the present disclosure;

FIG. 5B is another graphical illustration demonstrating capacity retention of an example battery cell including a negative electrode having hierarchical silicon columns and a solid sulfide electrolyte in accordance with various aspects of the present disclosure;

FIG. 5C is a graphical illustration demonstrating cell performance (i.e., charge-discharge profile at 0.1 C current rate) of an example battery cell including a negative electrode having hierarchical silicon columns and a solid sulfide electrolyte in accordance with various aspects of the present disclosure; and

FIG. 5D is another graphical illustration demonstrating cell performance (i.e., charge-discharge profile at 1 C current rate) of an example battery cell including a negative electrode having hierarchical silicon columns and a solid sulfide electrolyte in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology pertains to all-solid-state batteries (SSBs) and methods of forming and using the same. All-solid-state batteries are free of liquid or semi-liquid electrolytes. In various instances, all-solid-state batteries may have a bipolar stacking design. The bipolar stacking design includes, for example, a plurality of bipolar electrodes where a first mixture of solid-state electroactive material particles (and optional solid-state electrolyte particles) is disposed on a first side of a current collector, and a second mixture of solid-state electroactive material particles (and optional solid-state electrolyte particles) is disposed on a second side of a current collector that is parallel with the first side. The first mixture may include, as the solid-state electroactive material particles, cathode material particles. The second mixture may include, as solid-state electroactive material particles, anode material particles. The solid-state electrolyte particles in each instance may be the same or different.

In other variations, all-solid-state batteries may have a monopolar stacking design. The monopolar stacking design includes, for example, a plurality of monopolar electrodes where a first mixture of solid-state electroactive material particles (and optional solid-state electrolyte particles) is disposed on both a first side and a second side of a first current collector, where the first and second sides of the first current collector are substantially parallel, and a second mixture of solid-state electroactive material particles (and optional solid-state electrolyte particles) is disposed on both a first side and a second side of a second current collector, where the first and second sides of the second current collector are substantially parallel. The first mixture may include, as the solid-state electroactive material particles, cathode material particles. The second mixture may include, as solid-state electroactive material particles, anode material particles. The solid-state electrolyte particles in each instance may be the same or different. In certain variations, solid-state batteries may include a mixture of combination of bipolar and monopolar stacking designs.

Such all-solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

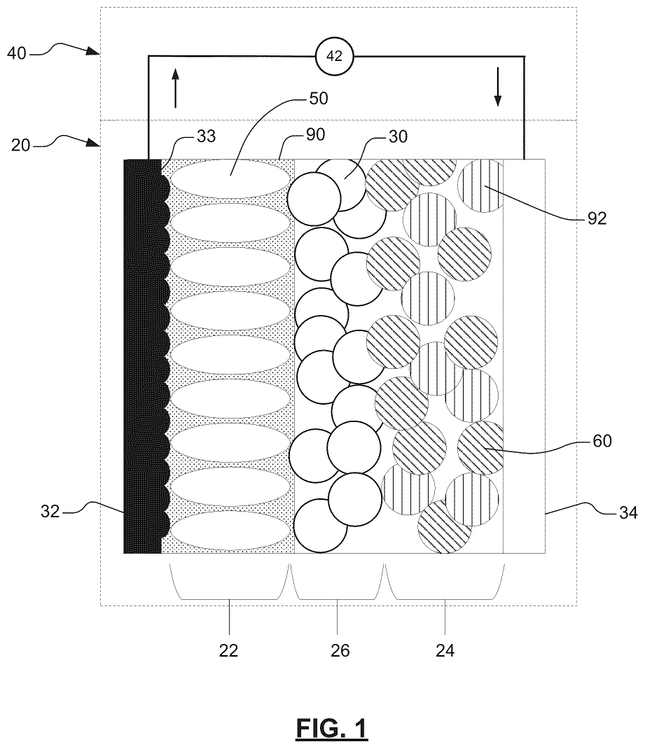

An exemplary and schematic illustration of a solid-state electrochemical cell unit (also referred to as a “all-solid-state battery” and/or “solid-state battery” and/or “battery”) 20 that cycles lithium ions is shown in FIG. 1. The battery 20 includes a negative electrode (i.e., anode) 22, a positive electrode (i.e., cathode) 24, and an electrolyte layer 26 that occupies a space defined between the electrodes. The electrolyte layer 26 is a solid-state separating layer that physically separates the negative electrode 22 from the positive electrode 24. The electrolyte layer 26 may include a first plurality of solid-state electrolyte particles 30. In certain variations, a second plurality of solid-state electrolyte particles 92 may be mixed with positive solid-state electroactive particles 60 in the positive electrode 24, and a solid sulfide electrolyte 90 may fill voids (or pores, or openings) between the negative solid-state electroactive particles 50.

A first current collector 32 may be positioned at or near the negative electrode 22. In certain instances, the first current collector 32 together with the negative electrode 22 may be referred to as a negative electrode assembly. The first current collector 32 may be a metal foil, metal grid or screen, or expanded metal comprising copper, stainless steel, nickel, iron, titanium, or any other appropriate electrically conductive material known to those of skill in the art. In certain variations, the first current collector 32 may have one or more roughened surfaces. For example, as illustrated, a surface 33 of the first current collector 32 facing the negative electrode 22 may be roughen. For example, the surface 33 may have a roughness (for example, a Rz, which is the difference between the tallest “peak” and the deepest “valley” in the surface) of greater than or equal to about or exactly 0 μm to less than or equal to about or exactly 12 μm, optionally greater than or equal to about or exactly 1 μm to less than or equal to about or exactly 12 μm, and in certain aspects, optionally about 8 μm. The roughness may help to improve adhesion of the first current collector 32 to the negative electrode 22, and more particularly, copper to the hierarchical silicon columns 50. In each instance, the first current collector 32 may have an average thickness greater than or equal to about or exactly 4 μm to less than or equal to about or exactly 30 μm, and in certain aspects, optionally about or exactly 18 μm.

A second current collector 34 may be positioned at or near the positive electrode 24. In certain instances, the second current collector 34 together with the positive electrode 24 may be referred to as a positive electrode assembly. The second current collector 34 may be a metal foil, metal grid or screen, or expanded metal comprising stainless steel, aluminum, nickel, iron, titanium, or any other appropriate electrically conductive material known to those of skill in the art. In certain variations, the second current collector 32 may be coated foil having improved corrosion resistance, such as graphene or carbon coated stainless steel foil. The second current collector 34 may have an average thickness greater than or equal to about or exactly 2 μm to less than or equal to about or exactly 30 μm.

Although not illustrated, the skilled artisan will recognize that in certain variations, the first current collector 32 may be a first bipolar current collector and/or the second current collector 34 may be a second bipolar current collector. For example, the first bipolar current collector 32 and/or the second bipolar current collector 34 may be a cladded foil, for example, where one side (e.g., the first side or the second side) of the current collector 32, 34 includes one metal (e.g., first metal) and another side (e.g., the other side of the first side or the second side) of the current collector 32 includes another metal (e.g., second metal). The cladded foil may include, for example only, aluminum-copper (Al—Cu), nickel-copper (Ni—Cu), stainless steel-copper (SS-Cu), aluminum-nickel (Al—Ni), aluminum-stainless steel (Al-SS), or nickel-stainless steel (Ni-SS). In certain variations, the first bipolar current collector 32 and/or second bipolar current collectors 34 may be pre-coated, such as graphene or carbon-coated aluminum current collectors.

The first current collector 32 and the second current collector 34 may be the same or different. In each instance, the first current collector 32 and the second electrode current collector 34 respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current (indicated by arrows in FIG. 1) during discharge by way of reversible electrochemical reactions that occur when the external circuit 40 is closed (to connect the negative electrode 22 and the positive electrode 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 towards the positive electrode 24. Lithium ions, which are also produced at the negative electrode 22, are concurrently transferred through the electrolyte layer 26 towards the positive electrode 24. The electrons flow through the external circuit 40 and the lithium ions migrate across the electrolyte layer 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back towards the negative electrode 22 through the external circuit 40, and the lithium ions, which move across the electrolyte layer 26 back towards the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

Though the illustrated example includes a single positive electrode 24 and a single negative electrode 22, the skilled artisan will recognize that the current teachings apply to various other configurations, including those having one or more cathodes and one or more anodes, as well as various current collectors and current collector films with electroactive particle layers disposed on or adjacent to or embedded within one or more surfaces thereof. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the electrolyte 26 layer.

In many configurations, each of the first current collector 32, the negative electrode 22, the electrolyte layer 26, the positive electrode 24, and the second current collector 34 are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). In various other instances, the battery 20 may further include electrodes 22, 24 connected in parallel to provide suitable electrical energy, battery voltage, and power for example, to yield a Parallel-Connected Elementary Cell Core (“PECC”).

The size and shape of the battery 20 may vary depending on the particular applications for which it is designed. Battery-powered vehicles and hand-held consumer electronic devices are two examples where the battery 20 would most likely be designed to different size, capacity, voltage, energy, and power-output specifications. The battery 20 may also be connected in series or parallel with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIG. 1, as introduced above, the electrolyte layer 26 provides electrical separation—preventing physical contact—between the negative electrode 22 and the positive electrode 24. The electrolyte layer 26 also provides a minimal resistance path for internal passage of ions. The electrolyte layer 26 may have an average thickness greater than or equal to about or exactly 1 μm to less than or equal to about or exactly 1,000 μm, optionally greater than or equal to about or exactly 5 μm to less than or equal to about or exactly 200 μm, optionally greater than or equal to about or exactly 10 μm to less than or equal to about or exactly 100 μm, optionally about or exactly 20 μm, and in certain aspects, optionally about or exactly 15 μm.

In various aspects, the electrolyte layer 26 may be defined by a first plurality of solid-state electrolyte particles 30. For example, the electrolyte layer 26 may be in the form of a layer or a composite that comprises the first plurality of solid-state electrolyte particles 30. The solid-state electrolyte particles 30 may have an average particle diameter greater than or equal to about or exactly 0.02 μm to less than or equal to about or exactly 20 μm, optionally greater than or equal to about or exactly 0.1 μm to less than or equal to about or exactly 10 μm, and in certain aspects, optionally greater than or equal to about or exactly 0.1 μm to less than or equal to about or exactly 5 μm. In certain variations, the solid-state electrolyte particles may include sulfide-based particles, hydride-based particles, halide-based particles, and/or other solid-state electrolyte particles having a low grain-boundary resistance (e.g., less than or equal to about or exactly 20 ohms at about or exactly 25° C.).

The sulfide-based particles may include, for example only, pseudobinary sulfides, pseudoternary sulfides, and/or pseudoquaternary sulfides. Example pseudobinary sulfide systems include Li₂S—P₂S₅ systems (such as, Li₃PS₄, Li₇P₃S₁₁, and Li_{9.6}P₃S₁₂), Li₂S—SnS₂systems (such as, Li₄SnS₄), Li₂S—SiS₂ systems, Li₂S—GeS₂ systems, Li₂S—B₂S₃ systems, Li₂S—Ga₂S₃ system, Li₂S—P₂S₃ systems, and Li₂S—Al₂S₃ systems. Example pseudoternary sulfide systems include Li₂O—Li₂S—P₂S₅ systems, Li₂S—P₂S₅—P₂O₅ systems, Li₂S—P₂S₅—GeS₂ systems (such as, Li_{3.25}Ge_{0.25}P_{0.75}S₄ and Li₁₀GeP₂S₁₂), Li₂S—P₂S₅—LiX systems (where X is one of F, Cl, Br, and I) (such as, Li₆PS₅Br, Li₆PS₅Cl, L₇P₂S₈I, and Li₄PS₄I), Li₂S—As₂S₅—SnS₂ systems (such as, Li_{3.833}Sn_{0.833}As_{0.166}S₄), Li₂S—P₂S₅—Al₂S₃ systems, Li₂S—LiX—SiS₂ systems (where X is one of F, Cl, Br, and I), 0.4LiI.0.6Li₄SnS₄, and Li₁₁Si₂PS₁₂. Example pseudoquaternary sulfide systems include Li₂O—Li₂S—P₂S₅—P₂O₅ systems, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂. The halide-based particles may include, for example only, Li₃YCl₆, Li₃InCl₆, Li₃YBr₆, LiI, Li₂CdCl₄, Li₂MgCl₄, LiCdI₄, Li₂ZnI₄, Li₃OCl, and combinations thereof. The hydride-based particles may include, for example only, LiBH₄, LiBH₄—LiX (where X=Cl, Br, or I), LiNH₂, Li₂NH, LiBH₄—LiNH₂, Li₃AlH₆, and combinations thereof.

Although not illustrated, the skilled artisan will recognize that in certain instances, the electrolyte layer 26 may include a binder. For example, the electrolyte layer 26 may include greater than or equal to about or exactly 0 wt. % to less than or equal to about or exactly 10 wt. %, and in certain aspects, optionally greater than or equal to about or exactly 0.5 wt. % to less than or equal to about or exactly 10 wt. %, of the binder. The binder may include, for example only, polyvinylidene difluoride (PVDF), polytetrafluoroethylene (PTFE), ethylene propylene diene monomer (EPDM) rubber, nitrile butadiene rubber (NBR), styrene-butadiene rubber (SBR), lithium polyacrylate (LiPAA), and combinations thereof.

The positive electrode 24 (also referred to as a positive electroactive material layer) is defined by a plurality of the positive solid-state electroactive particles 60. In certain instances, as illustrated, the positive electrode 24 is a composite comprising a mixture of the positive solid-state electroactive particles 60 and a second plurality of solid-state electrolyte particles 92. For example, the positive electrode 24 may include greater than or equal to about or exactly 30 wt. % to less than or equal to about or exactly 98 wt. %, and in certain aspects, optionally greater than or equal to about or exactly 50 wt. % to less than or equal to about or exactly 95 wt. %, of the positive solid-state electroactive particles 60, and greater than or equal to about or exactly 0 wt. % to less than or equal to about or exactly 50 wt. %, and in certain aspects, optionally greater than or equal to about or exactly 5 wt. % to less than or equal to about or exactly 20 wt. %, of the second plurality of solid-state electrolyte particles 92. In each variation, the positive electrode 24 may have be in the form of a layer having an average thickness greater than or equal to about or exactly 10 μm to less than or equal to about or exactly 500 μm, optionally greater than or equal to about or exactly 10 μm to less than or equal to about or exactly 100 μm, and in certain aspects, optionally about 40 μm.

The second plurality of solid-state electrolyte particles 92 may be the same as or different form the first plurality of solid-state electrolyte particles 30. In certain variations, the positive electrode 24 may be one of a layered-oxide cathode, a spinel cathode, a polyanion cathode, and an olivine cathode. In the instances of the layered-oxide cathode (e.g., rock salt layered oxides), the positive solid-state electroactive particles 60 may include one or more positive electroactive materials selected from LiCoO₂, LiNiₓMn_{y}Co_{1-x-y}O₂ (where 0≤x≤1 and 0≤y≤1), LiNiₓMn_{y}Al_{1-x-y}O₂ (where 0<x≤1 and 0<y≤1), LiNiₓMn_{y}Co₂Al_{1-x-y-z}O₂ (where 0≤x≤1, 0≤y≤1, and 0≤z≤1), LiNiₓMn₁₋ₓO₂ (where 0≤x≤1), and Li₁₊ₓMO₂ (where 0≤x≤1). In the instance of the spinel cathode, the positive solid-state electroactive particles 60 may include positive electroactive materials like LiMn₂O₄ and LiNi_{0.5}Mn_{1.5}O₄. In the instance of the polyanion cathode, the positive solid-state electroactive particles 60 may include positive electroactive materials like LiFePO₄, LiVPO₄, LiV₂(PO₄)₃, Li₃Fe₃(PO₄)₄, and Li₃V₂(PO₄)F₃. In the instance of the olivine cathode, the positive solids-state electroactive particles 60 may include positive electroactive materials like Li₂FePO₄ and LiMnₓFe₁₋ₓPO₄ (where 0.6<x≤0.8). In other variations, the positive electrode 24 may include a low-voltage (e.g., <3 V vs. Li/Li+) cathode material, like lithium metal oxide/sulfide (such as, LiTiS₂) lithium sulfide, sulfur, and the like. In each variation, the positive solid-state electroactive particles 60 may be coated (for example, by LiNbO₃ and/or Al₂O₃) and/or the positive electroactive material may be doped (for example, by aluminum and/or magnesium).

Although not illustrated, in certain variations, the positive electrode 24 may further include one or more additives, for example conductive additives and/or binder additives. For example, the positive electrode 24 may include greater than or equal to about or exactly 30 wt. % to less than or equal to about or exactly 98 wt. %, and in certain aspects, optionally greater than or equal to about or exactly 50 wt. % to less than or equal to about or exactly 98 wt. %, of the positive solid-state electroactive particles 60; greater than or equal to about or exactly 0 wt. % to less than or equal to about 50 wt. %, and in certain aspects, optionally greater than or equal to about or exactly 0 wt. % to less than or equal to about or exactly 30 wt. %, of the second plurality of solid-state electrolyte particles 92; greater than or equal to about or exactly 0 wt. % to less than or equal to about or exactly 30 wt. %, and in certain aspects, optionally greater than or equal to about or exactly 0 wt. % to less than or equal to about or exactly 10 wt. %, of the conductive additives; and greater than or equal to about or exactly 0 wt. % to less than or equal to about 20 wt. %, and in certain aspects, optionally greater than or equal to about or exactly 0 wt. % to less than or equal to about or exactly 10 wt. %, of the binder additives.

Conductive additives may include, for example, carbon-based materials like graphite, acetylene black (such as KETCHEN™ black or DENKA™ black), carbon nanofibers and nanotubes, graphene (such as graphene oxide), carbon black (such as Super P), and the like. Binder additives may include, for example, polyvinylidene difluoride (PVDF), poly(vinylidene fluoride-co-hexafluoropropylene (PVDF-HFP), polytetrafluoroethylene (PTFE), sodium carboxymethyl cellulose (CMC), ethylene propylene diene monomer (EPDM) rubber, nitrile butadiene rubber (NBR), styrene-butadiene rubber (SBR), styrene ethylene butylene styrene copolymers (SEBS), styrene butadiene styrene copolymers (SBS), polyethylene glycol (PEO), lithium polyacrylate (LiPAA), and the like.

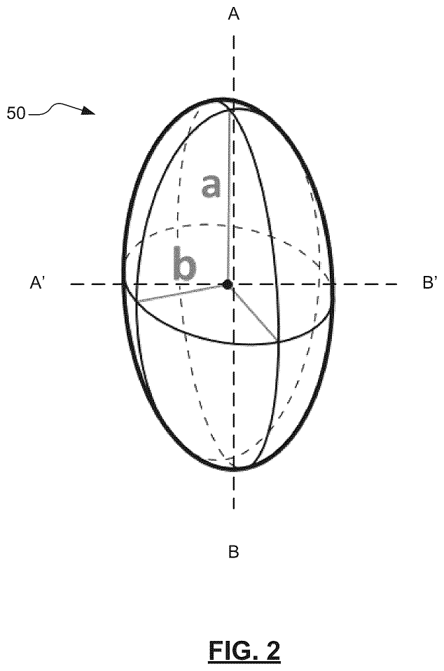

The negative electrode 22 (also referred to as a negative electroactive material layer) is defined by a plurality of the negative solid-state electroactive particles 50. In certain variations, the negative solid-state electroactive particles 50 are hierarchical silicon columns (such as illustrated in FIG. 2), where a longest length A-B of each silicon column 50 is substantially perpendicular with a major axis of the current collector 32, and also, a major axis of the electrolyte layer 26. The hierarchical silicon columns 50 have a general oval shape where a first radius (a) is greater than a second radius (b). For example, the first radius (a) may be greater than or equal to about or exactly 0.5 μm to less than or equal to about or exactly 40 μm, and in certain aspects, optionally about or exactly 3.5 μm, and a second radius (b) may be greater than or equal to about or exactly 0.5 μm to less than or equal to about or exactly 40 μm, and in certain aspects, optionally about or exactly 3 μm. The hierarchical silicon columns 50 may have an areal capacity greater than or equal to about or exactly 0.5 mAh/cm² to less than or equal to about or exactly 20 mAh/cm², and in certain aspects, optionally greater than or equal to about or exactly 2 mAh/cm² to less than or equal to about or exactly 4 mAh/cm².

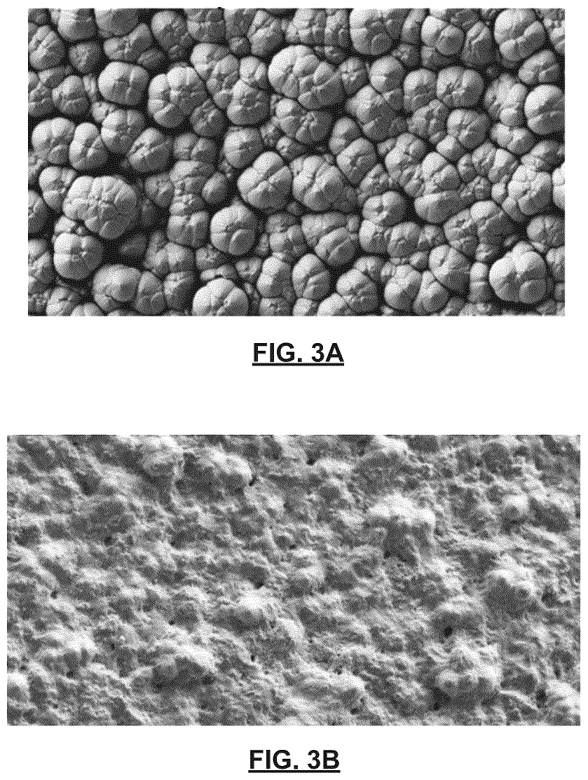

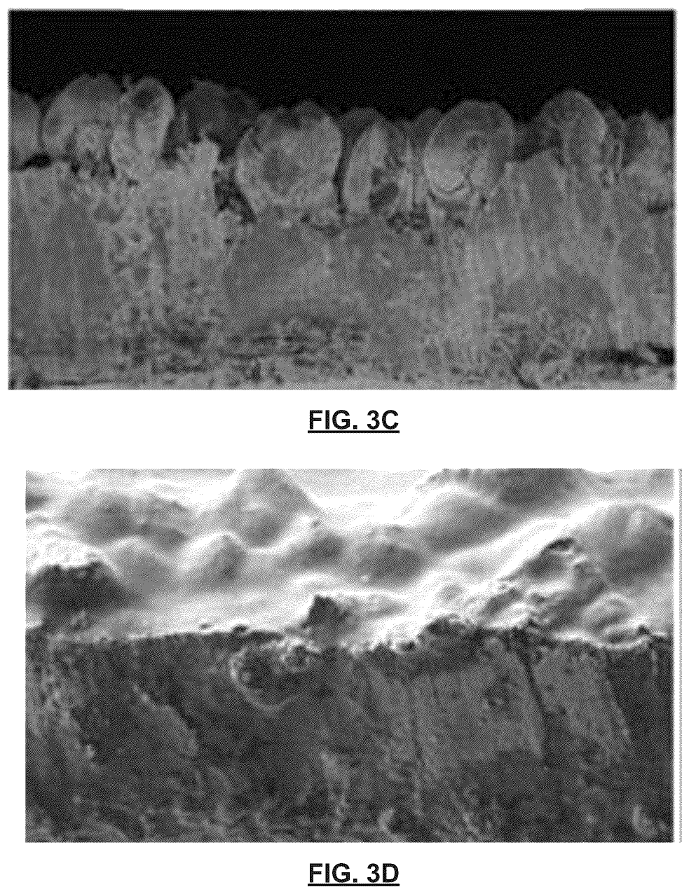

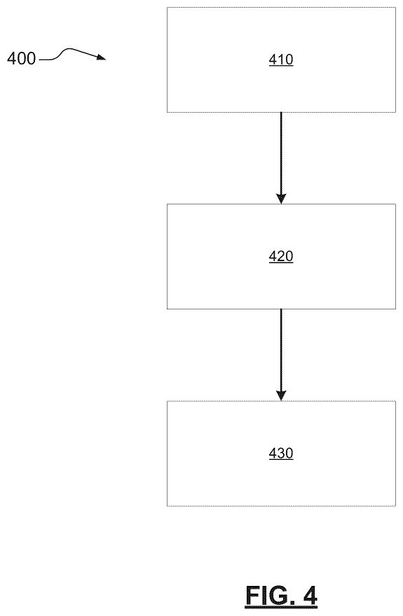

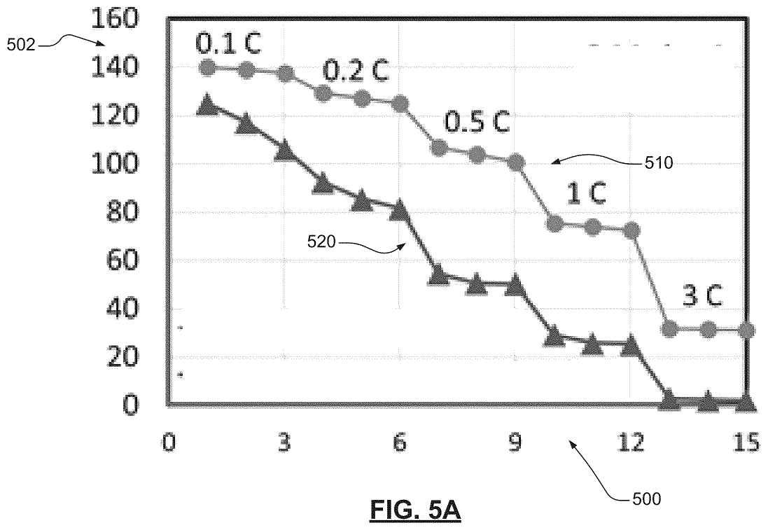

The negative electrode 22 further includes a solid sulfide electrolyte 90 that is disposed between, for example, fills voids (or pores, or spaces) between, the hierarchical silicon columns 50. For example, FIG. 3A is a top-down scanning electron microscopy image of a surface of a negative electrode not having a solid sulfide electrolyte, while FIG. 3B is a top-down scanning electron microscopy image of a negative electrode like the current negative electrode including hierarchical silicon columns 50 and solid sulfide electrolyte 90. Similarly, FIG. 3C is a scanning electron microscopy image of a cross section of the negative electrode not having a solid sulfide electrolyte, while FIG. 3D is a scanning electron microscopy image of a cross section of the negative electrode like the current negative electrode including hierarchical silicon columns 50 and solid sulfide electrolyte 90. As illustrated, the solid sulfide electrolyte 90 helps to build up favorable solid-solid electrode-electrolyte interfaces with initiate ionic contacts thereby promoting lithium-ion conduction within the negative electrode 22. In various aspects, as further detailed below, the solid sulfide electrolyte 90 may be formed in-situ.

The solid sulfide electrolyte 90 may fill greater than or equal to about or exactly 60 vol. % to less than or equal to about or exactly 100 vol. %, and in certain aspects, optionally greater than or equal to about or exactly 80% to less than or equal to about or exactly 100 vol. %, of the voids between the hierarchical silicon columns 50. For example, the negative electrode 22 may include greater than or equal to about or exactly 70 wt. % to less than or equal to about or exactly 100 wt. %, and in certain aspects, optionally greater than or equal to about or exactly 80 wt. % to less than or equal to about or exactly 100 wt. %, of the hierarchical silicon columns 50; and greater than or equal to about or exactly 0 wt. % to less than or equal to about or exactly 30 wt. %, optionally greater than or equal to about or exactly 5 wt. % to less than or equal to about or exactly 30 wt. %, and in certain aspects, optionally greater than or equal to about or exactly 5 wt. % to less than or equal to about or exactly 25 wt. %, of the solid-sulfide electrolyte 90. The solid sulfide electrolyte 90 may have an areal content (i.e., mass loading in the negative electrode 22) of greater than or equal to about or exactly 0 mg/cm² to less than or equal to about 1 mg/cm², and in certain aspects, optionally about 0.25 mg/cm².

In certain variations, the solid-sulfide electrolyte 90 may include, for example only, pseudobinary sulfides, pseudoternary sulfides, and/or pseudoquaternary sulfides. Example pseudobinary sulfide systems include Li₂S—P₂S₅ systems (such as, Li₃PS₄, Li₇P₃S₁₁, and Li_{9.6}P₃S₁₂), Li₂S—SnS₂ systems (such as, Li₄SnS₄), Li₂S—SiS₂ systems, Li₂S—GeS₂ systems, Li₂S—B₂S₃ systems, Li₂S—Ga₂S₃ system, Li₂S—P₂S₃ systems, and Li₂S—Al₂S₃ systems. Example pseudoternary sulfide systems include Li₂O—Li₂S—P₂S₅ systems, Li₂S—P₂S₅—P₂O₅ systems, Li₂S—P₂S₅—GeS₂ systems (such as, Li_{3.25}Ge_{0.25}P_{0.75}S₄ and Li₁₀GeP₂S₁₂), Li₂S—P₂S₅—LiX systems (where X is one of F, Cl, Br, and I) (such as, Li₆PS₅Br, Li₆PS₅Cl, L₇P₂S₈I, and Li₄PS₄I), Li₂S—As₂S₅—SnS₂ systems (such as, Li_{3.833}Sn_{0.833}As_{0.166}S₄), Li₂S—P₂S₅—Al₂S₃ systems, Li₂S—LiX—SiS₂ systems (where X is one of F, Cl, Br, and I), 0.4LiI.0.6Li₄SnS₄, and Li₁₁Si₂PS₁₂. Example pseudoquaternary sulfide systems include Li₂O—Li₂S—P₂S₅—P₂O₅ systems, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂. The electrolyte 90 may be the same as or different from the electrolyte 30 and/or the electrolyte 92.

Although not illustrated, in certain variations, the negative electrode 22 may also include a plurality of solid-state graphite particles coated on or disbursed between the hierarchical silicon columns 50. For example, the negative electrode 22 may include greater than or equal to about or exactly 0 wt. % to less than or equal to about or exactly 90 wt. %, and in certain aspects, optionally greater than or equal to about or exactly 0 wt. % to less than or equal to about or exactly 70 wt. %, of solid-state graphite particles. The solid-state graphite particles may have an average particle size greater than or equal to about or exactly 0.05 μm to less than or equal to about 20 μm. In certain variations, the solid-state graphite particles acting as a secondary electroactive material may enhance the battery cycling performance such as the capacity retention. Notably, in each variation, the negative electrode 22 is substantially free (e.g., greater than or equal to about or exactly 99.9%) from conductive additives and/or binder additive. The exclusion of common conductive additives is notable because conductive additives, and in particular, carbon additives, may trigger sulfide electrolyte decomposition. The exclusion of common binder additives is possible because the silicon can be tightly bonded onto the first current collector 32 (and in particular, a roughened current collector) through a physical vapor deposition process.

In various aspects, the present disclosure provides methods for forming columnar silicon anodes. For example, FIG. 3 illustrates an example method 400 for forming a negative electrode including columnar silicon, like negative electrode 22 illustrated in FIG. 1. The method 400 may include contacting 420 a columnar silicon anode film (or sheet-type columnar silicon anode) and a precursor electrolyte solution to form a precursor assembly. The columnar silicon anode film may include a current collector (like the first current collector 32 illustrated in FIG. 1) and a plurality of hierarchical silicon columns disposed along one or more sides of the current collector, where a longest length A-B of each silicon column is substantially perpendicular with a major axis of the current collector. In certain variations, the method 400 may include forming 410 the columnar silicon anode film. The columnar silicon anode film may be formed using a controlled physical vapor deposition (PVD) process. The controlled physical vapor deposition process may include three general steps: (1) vaporization of the silicon material from a strong source, (2) transportation of the disintegrated silicon material, and (3) nucleation and development to create the columnar silicon anode film.

The precursor electrolyte solution may include pseudobinary sulfides, pseudoternary sulfides, and/or pseudoquaternary sulfides, like those detailed above, as well as a solvent selected from the group consisting of: tetrahydrofuran, ethyl propionate, ethylacetate, acetonitrile, water, N-methyl formamide, methanol, ethanol, 1,2-dimethoxyethane, and combinations thereof. The precursor electrolyte solution may include greater than or equal to about or exactly 1 wt. % to less than or equal to about or exactly 20 wt. %, and in certain aspects, optionally greater than or equal to about or exactly 2 wt. % to less than or equal to about or exactly 15 wt. %, of the sulfide electrolyte; and greater than or equal to about or exactly 80 wt. % to less than or equal to about or exactly 99 wt. %, and in certain aspects, optionally greater than or equal to about or exactly 85 wt. % to less than or equal to about or exactly 98 wt. %, of the solvent. In each variation, contacting 420 may include causing the precursor electrolyte solution to flow into and substantially fill voids (or pores, or spaces) between the hierarchical silicon columns defining the columnar silicon anode film. In certain variation, the contacting 420 may include using a vacuum infiltration process to impregnate the voids between the hierarchical silicon columns. In other variations, the contacting 420 may include coating, dropping, and/or spraying.

In various aspects, the method 400 further includes removing 430 the solvent from the precursor assembly to form the negative electrode including columnar silicon. In certain variations, removing 430 the solvent may include heating the precursor assembly to a temperature greater than or equal to about or exactly 60° C. to less than or equal to about or exactly 200° C., and in certain aspects, optionally about or exactly 150° C., and holding the precursor assembly within the noted temperature range for a period greater than or equal to about or exactly 2 hours to less than or equal to about or exactly 20 hours, and in certain aspects, optionally about or exactly 16 hours.

Certain features of the current technology are further illustrated in the following non-limiting examples.

### EXAMPLE 1

Example battery cells may be prepared in accordance with various aspects of the present disclosure.

For example, an example battery cell 510 may be prepared that includes a negative electrode having hierarchical silicon columns and a solid sulfide electrolyte—for example, like the battery 20 illustrated in FIG. 1. The example battery cell 510 may have an anode loading of about or exactly 2.0 mAh/cm², and a cathode loading of about or exactly 0.8 mAh/cm². A comparative cell 520 may have a similar battery configuration, but omitting the solid sulfide electrolyte.

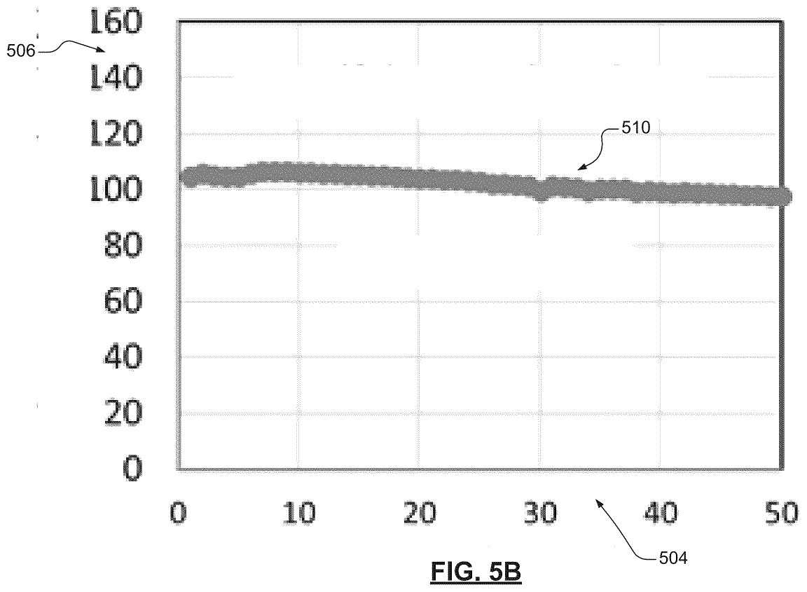

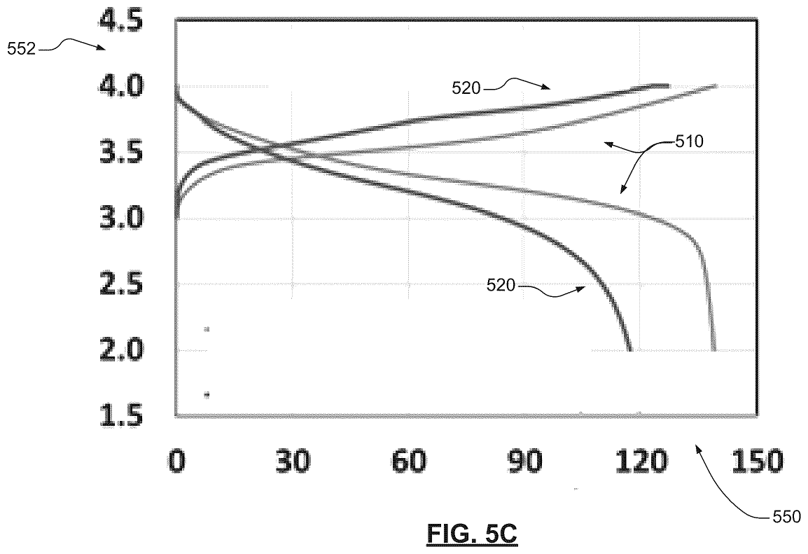

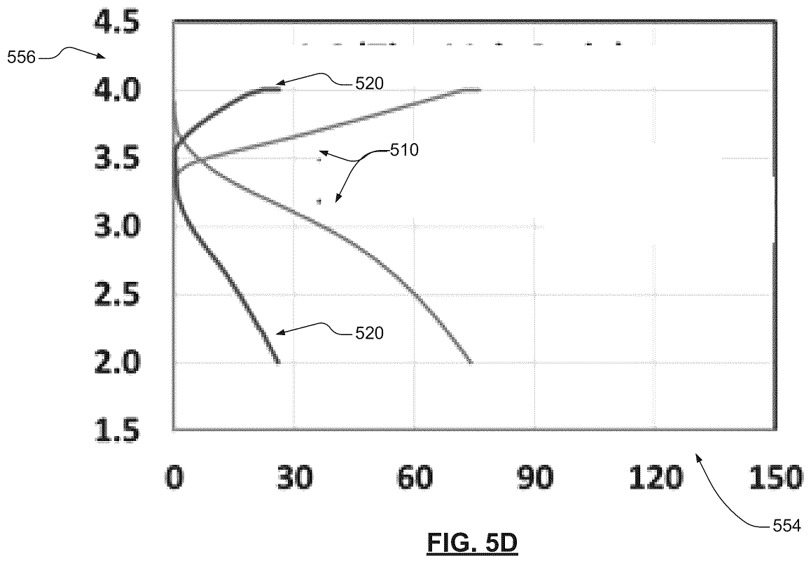

FIG. 5A is a graphical illustration demonstrating rate performance of the example battery cell 510, as compared to the comparative cell 520, at 30° C., where the x-axis 500 represents cycle number and the y-axis 502 represents discharge capacity (mAh/g). The example battery cell 510 demonstrated an enhance rate performance compared with the comparative cell 520, especially at 1 C current rate, which is attributable to the promoted lithium-ion conduction contributed by solid sulfide electrolyte at interfaces between silicon columns. FIG. 5B is another graphical illustration demonstrating capacity retention of the example battery cell 510 at 30° C. with a current rate of 1 C, where the x-axis 504 represents cycle number and the y-axis 506 represents discharge capacity (mAh/g). As illustrated, the capacity of the example battery cell 510 experiences almost no changed within 50 cycles.

FIG. 5C is a graphical illustration demonstrating cell performance (charge-discharge profiles) of the example battery cell 510, as compared to the comparative cell 520, at 30° C. with a current rate of 0.1 C, where the x-axis 550 represents capacity (mAh/g) and the y-axis 552 represents voltage. FIG. 5D is another graphical illustration demonstrating cell performance (charge-discharge profiles) of the example battery cell 510, as compared to the comparative cell 520, at 30° C. with a current rate of 1 C, where the x-axis 554 represents capacity (mAh/g) and the y-axis 556 represents voltage. As illustrated, the example battery cell 510 demonstrated a reduced voltage polarization compared with the comparative cell 520, suggesting a reduced interfacial resistance of the example battery cell 510.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode for an all-solid-state electrochemical cell, the electrode comprising:
a plurality of hierarchical silicon columns defining an electroactive material layer, the electroactive material layer having a vacant space defined by openings between the plurality of hierarchical silicon columns; and
a solid sulfide electrolyte formed in-situ filling greater than or equal to about 60 vol. % to less than or equal to about 100 vol. % of the vacant space in the electroactive material layer.

2. The electrode of claim 1, wherein each of the hierarchical silicon columns has a general oval shape where a first radius is larger than a second radius, the first radius being greater than or equal to about 0.5 μm to less than or equal to about 40 μm, and the second radius being greater than or equal to about 0.5 μm to less than or equal to about 40 μm,
wherein each of the hierarchical silicon columns has an areal capacity greater than or equal to about 0.5 mAh/cm² to less than or equal to about 20 mAh/cm².

3. The electrode of claim 2, wherein the first radius is about 3.5 μm, and the second radius is about 3 μm.

4. The electrode of claim 1, wherein the electroactive material layer comprises:
greater than or equal to about or exactly 70 wt. % to less than or equal to about or exactly 100 wt. % of the plurality of hierarchical silicon columns; and
greater than 5 wt. % to less than or equal to about or exactly 30 wt. % of the solid sulfide electrolyte.

5. The electrode of claim 1, wherein the electroactive material layer further comprises:
solid-state graphite particles coated on or dispersed between the hierarchical silicon columns, wherein the vacant spaces are defined as any openings in the electroactive material layer not occupied by the plurality of hierarchical silicon columns and the solid-state graphite particles.

6. The electrode of claim 5, wherein the electroactive material layer comprises greater than 0 wt. % to less than or equal to about 70 wt. % of the solid-state graphite particles, the solid-state graphite particles having an average particle size greater than or equal to about 0.05 μm to less than or equal to about 20 μm.

7. The electrode of claim 1, wherein the electrode further comprises:
a current collector having a roughened surface disposed on or adjacent to the electroactive material layer, wherein a longest dimension of each hierarchical silicon column is perpendicular to a major axis of the current collector.

8. The electrode of claim 7, wherein the roughened surface has a Rz greater than 1 μm to less than or equal to about 12 μm.

9. An all-solid-state electrochemical cell that cycles lithium ions, wherein the electrochemical cell comprises:
a first electrode comprising:
a first current collector, and
a first electroactive material layer disposed on or adjacent to the first current collector;
a second electrode comprising
a second electroactive material layer disposed on or adjacent to the second current collector, the second electroactive material layer comprising:
a plurality of hierarchical silicon columns, and
a solid sulfide electrolyte formed in-situ filling greater than or equal to about 60 vol. % to less than or equal to about 100 vol. % of voids in the second electroactive material layer, the voids being defined by openings between the hierarchical silicon columns, a longest dimension of each hierarchical silicon columns being perpendicular to the major axis of the second current collector; and
a solid-state electrolyte layer disposed between the first electroactive material layer and the second electroactive material layer.

10. The electrochemical cell of claim 9, wherein each of the hierarchical silicon columns has a general oval shape where a first radius is larger than a second radius, the first radius being greater than or equal to about 0.5 μm to less than or equal to about 40 μm, and the second radius being greater than or equal to about 0.5 μm to less than or equal to about 40 μm, and
each of the hierarchical silicon columns has an areal capacity greater than or equal to about 0.5 mAh/cm² to less than or equal to about 20 mAh/cm².

11. The electrochemical cell of claim 9, wherein the electroactive material layer further comprises:
greater than 0 wt. % to less than or equal to about 70 wt. % of solid-state graphite particles coated on or disbursed between the hierarchical silicon columns, the voids defined by any openings in the second electroactive material layer not occupied by the hierarchical silicon columns and the solid-state graphite particles, the solid-state graphite particles having an average particle size greater than or equal to about 0.05 μm to less than or equal to about 20 μm.

12. The electrochemical cell of claim 9, wherein the current collector has a roughened surface and the electroactive material layer is disposed on or adjacent to roughened surface of the current collector, the roughened surface having a Rz greater than 1 μm to less than or equal to about 12 μm.

13. A method for forming an electrode, the electrode comprising a plurality of hierarchical silicon columns and a solid sulfide electrolyte, the method comprising:
contacting a columnar silicon anode film comprising the hierarchical silicon columns and a precursor electrolyte solution to form a precursor assembly, the precursor electrolyte solution filling voids in the columnar silicon anode film, the voids defined by openings between the hierarchical silicon columns, the precursor electrolyte solution comprises a plurality of sulfide particles and a solvent; and
removing the solvent from the precursor assembly to form the solid sulfide electrolyte.

14. The method of claim 13, wherein the solvent is selected from the group consisting of: tetrahydrofuran, ethyl propionate, ethylacetate, acetonitrile, water, N-methyl formamide, methanol, ethanol, 1,2-dimethoxyethane, and combinations thereof.

15. The method of claim 13, wherein the method further comprises forming the columnar silicon anode film, the forming utilizing a controlled physical vapor deposition (PVD) process.

16. The method of claim 13, wherein each of the hierarchical silicon columns has a general oval shape where a first radius is larger than a second radius, the first radius being greater than or equal to about 0.5 μm to less than or equal to about 40 μm, and the second radius being greater than or equal to about 0.5 μm to less than or equal to about 40 μm, and each of the hierarchical silicon columns has an areal capacity greater than or equal to about 0.5 mAh/cm² to less than or equal to about 20 mAh/cm².

17. The method of claim 13, wherein the removing of the solvent comprises heating the precursor assembly to a temperature greater than or equal to about 60° C. to less than or equal to about 200° C., and holding the temperature for a period greater than or equal to about 2 hours to less than or equal to about 20 hours.

18. The method of claim 13, wherein the columnar silicon anode film further comprises a current collector, the hierarchical silicon columns being disposed near or adjacent to one or more surfaces of the current collector, a longest dimension of each hierarchical silicon column being perpendicular to a major axis of the current collector.

19. The method of claim 13, wherein the columnar silicon anode film further comprises greater than 0 wt. % to less than or equal to about 70 wt. % of solid-state graphite particles coated on or disbursed between the hierarchical silicon columns, the voids defined by any openings in the second electroactive material layer not occupied by the hierarchical silicon columns and the solid-state graphite particles, and the solid-state graphite particles having an average particle size greater than or equal to about 0.05 μm to less than or equal to about 20 μm.

20. The method of claim 13, wherein the contacting comprises vacuum infiltration of the columnar silicon anode film with the precursor electrolyte solution.
